(19) United States
(12) Patent Application Publication
(10) Pub. No.: US 2009/0269605 A1
(43) Pub. Date: Oct. 29, 2009

(54) Composite Preform Having a Controlled Fraction of Porosity in at Least One Layer and Methods for Manufacture and Use

(76) Inventors: Virendra S. Warke, Lowell, MA (US); Stephen J. Mashl, Chelmsford, MA (US)

Correspondence Address: SUMMA, ADDITON & ASHE, P.A., 11610 NORTH COMMUNITY HOUSE ROAD, SUITE 200, CHARLOTTE, NC, 28277, US

(21) Appl. No.: 12/429,752

(22) Filed: Apr. 24, 2009

Related U.S. Application Data
(60) Provisional application No. 61/047,494, filed on Apr. 24, 2008.

(51) Int. Cl. B32B 5/18; B32B 15/00; B23K 31/12

(52) U.S. Cl. 428/550; 228/176; 228/104

(57) ABSTRACT

The invention provides clad billet for hot working plastic deformation processes for the production of clad products, including, but not limited to, clad pipe and tubing by extrusion of a hollow, bicomponent composite billet having a fully dense structural component and a partially dense component of a specialty alloy at a fraction of porosity predetermined to provide a flow stress compatible with that of the structural component. The components are diffusion bonded to the predetermined fraction of porosity in the specialty component by application of heat and pressure over time, including by hot isostatically pressing the billet components. Computer modeling techniques can be used to determine processing conditions for obtaining flow stress compatibility.

### CROSS-REFERENCE TO RELATED APPLICATIONS

This application claims priority from provisional application Ser. No. 61/047,494 filed Apr. 24, 2008 for “Multi-component Pre-form Having Controlled Porosity for Production of Clad Products and Methods for Producing Pre-form and Clad Products” the contents of which is incorporated entirely herein by reference.

### FIELD OF THE INVENTION

This invention relates to composite preforms, commonly referred to as “billets,” that are used as the input material for producing clad pipe and tubing and other clad products, and to methods for producing these composite performs.

### BACKGROUND OF THE INVENTION

Alloys commonly used to fabricate pipe or tubing often have the bulk structural properties needed for general applications but may be unsuitable for extended use in connection with highly corrosive or otherwise aggressive fluids, including liquids, gases, and slurries. Other less commonly used alloys may be more resistant to corrosion or wear or have another desirable property, but may contain complex and costly alloying ingredients or lack sufficient structural or other properties to provide a practical alternative to more common alloys. One method of obtaining both the needed structural properties and the specific special properties has been to clad one alloy to another to produce composite products having bonded layers of different alloys, thus sharing the qualities and benefits of each alloy component while mitigating the disadvantages of each. Structural components are sometimes bonded to wear and corrosion resistant components, the wear and corrosion resistant components facing the aggressive fluid and the structural component supporting the wear and corrosion resistant components.

For example, clad steels are often used in harsh environments requiring enhanced longevity or other special properties. Steel alloys are strong, but may not be able to withstand certain harsh conditions for extended periods. Seamless tubing made from mild steel clad with a nickel-based superalloy, including, for example, Inconel® 625 from Special Metals Corporation, may provide enhanced corrosion resistance to certain liquids and slurries on the Inconel 625 side, while the steel provides the required strength. Clad products such as Inconel clad steel typically cost less than Inconel alone and have enhanced performance compared to products made solely from steel. However, Inconel and steel do not normally exhibit properties that are compatible for efficient production of clad piping by hot working plastic deformation techniques. Researchers and industry practitioners experienced in hot working of composite materials have learned that the flow stress of multiple layers cannot differ by more than a factor of approximately 2.3. The flow stress is that stress required to plastically deform a material at a specific hot working temperature.

The composite billet that enters the hot working process is comprised of multiple layers. Each layer may initially be fabricated separately. These components that make up the individual layers of the composite billet are then assembled to produce the composite billet. Adjacent layers may be nested, one within the other, or they may be mechanically or metallurgically bonded to each other by various techniques, including welding, brazing, diffusion bonding, or encapsulation.

Plastic deformation of composite, multi-component billets often provides low yields. Shear forces sufficient to change the dimensions of the structure permanently, as by extrusion, Pilger milling, or other plastic deformation techniques, can cause any of several types of structural failure. Component flow may not be uniform, the diameter of one component may not change in proportion to the other or may not change at all, and one or the other components may fracture, to name a few.

Various attempts have been made to overcome the limitations imposed by the differences in flow stress of each component layer when hot working composite multi-component billets. These processes, such as extrusion or Pilger milling, are attractive because they enable production of long lengths of clad pipe and tubing in an efficient manner. The components that comprise the layers in a billet can be selected from groups of components that tend to have similar extrusion or other working properties to avoid fractures and discontinuities or other problems.

Processing conditions, including temperature, may be modified for each component. As shown by the shaded area of FIG. 16, labeled “prior art,” the range of acceptable flow stresses for a corrosion resistant or wear resistant alloy applied to carbon steel excludes many candidates even with modification of component temperature. Modifying temperature necessitates rapid processing of the billet because the temperatures of the components tend to rapidly equilibrate once the components are in contact with each other. In some cases, the deformation of a multi-layered billet at relatively high processing temperatures can improve the chances of producing a good product, however, high temperature processing can be detrimental to the materials involved, resulting in grain growth, precipitate coarsening, and other undesirable occurrences and the range of acceptable parameters is somewhat limiting.

It would be desirable to develop alternative, less problematic solutions for the production of clad pipe and tubing and other products from multi-component preforms by plastic deformation processing.

### SUMMARY OF THE INVENTION

The invention provides a billet or preform in which at least one component or layer is made using powder metallurgy (“PM”) techniques and methods for making the billet, including controlling the amount and characteristics of the porosity within the at least one PM component, including adjusting the pore volume of at least one of the powder components of the billet to provide a flow stress under plastic deformation that is compatible with the flow stress of the other component. The characteristics of the porosity within a PM component that can be controlled include the pore volume, the pore size, and the pore size distribution. Compatibility of flow stresses enables bonded billet components to undergo plastic deformation with decreased probability of failure and for the products obtained thereby to retain the integrity of the bond between the components.

In a specific embodiment, clad pipe or tubing can be produced by the practice of the invention from billets in which the porosity of at least one PM component is controlled to provide a flow stress compatible with that of the other components or layers that make up the billet. The characteristics of porosity, and thus flow stress, of a component, can be controlled by any of several methods, including hot isostatic pressing at predetermined conditions of pressure, temperature, and time and cold isostatic pressing at predetermined conditions of pressure and time followed by sintering so that the corresponding flow stress induced upon plastic deformation approaches that of the at least one other component.

For example, carbon steel and Inconel 625, a highly corrosion resistant nickel-based superalloy, have flow stresses that normally are so different as to be incompatible for trouble free plastic deformation processing. By practice of the invention, the porosity of Inconel 625 in a billet with carbon steel can be adjusted to a predetermined level to decrease the flow stress of the Inconel 625 and provide a flow stress ratio of Inconel 625 to carbon steel of less than 2.3. Flow of Inconel 625 during processing should be concentric and the potential for failure during process diminished under these conditions.

In a specific embodiment of the practice of the method of the invention, a hollow blank is produced from, for example, wrought carbon steel, a casting, or a powder metallurgy steel. A capsule is fabricated from sheet metal and welded to the blank to create either an internal and/or an external annular cavity, depending on whether the carbon steel is to form the internal and/or external surface of clad tubing. The assembly of the carbon steel blank and the capsule is vibrated while the annular cavity is filled with an alloy powder of spherical particles of an alloy having a desirable property, including, for example, a corrosion resistant alloy or a wear resistant alloy. The powder is vibrated to maximize its packed density, which is typically from about 62 to 72% of theoretical full density. Full density is the density of the material in the absence of pores between the spherical powder particles. Thereafter, the capsule is evacuated of air, water vapor, and other gases, heated to further remove the gaseous impurities, and sealed. The sealed capsule is then subjected to hot isostatic pressing (“HIP”) to consolidate the powder under conditions of temperature, pressure, and cycle time. The specific temperature, pressure and cycle time used are chosen to yield a pre-selected preselected pore density in that component. That pore density value selected to produce a component that will have a flow stress compatible to that of the other components that make up the layers in the composite billet.

HIPing, or other techniques of applying controlled pressure, temperature, and time, including cold isostatic pressing (“CIPing”) followed by application of heat by sintering, creates a metallurgical bond between the powder particles and controls the pore volume within the resulting PM component, thus also controlling the flow stress of that component. By controlling the pore fraction within specific layers or components that make up a billet, the flow stresses of the components can be controlled so that they are sufficiently close. Then the bicomponent billet can undergo plastic deformation and yield the desired product.

It should be recognized that, in an alternate embodiment, those components powder metallurgy can be prepared separately rather than filling an annular space with powder. In this event, the powder component is processed to achieve a preselected fraction of porosity and the porous component is then placed adjacent the other components. For example, a porous blank of Inconel 625 alloy can be machined and nested into a wrought or cast sleeve and then, if desired, treated to bond these layers. HIP, CIP and sinter, or other similar bonding method may be accomplished at conditions to bond the components while avoiding further densification of the powder layer if the preselected density has already been achieved. Alternatively, if additional densification is desired to reach a target density, then the bonding conditions can be altered to achieve the desired target density. In a further alternative embodiment, more than two components can be used, at least one of which is a powder of adjustable porosity. Each of the components can be made using PM techniques, if desired.

A wrought or cast blank that is to be clad on two sides with different powder components may be used in the practice of the invention. The components may include metals, alloys, plastics, and ceramics and composite materials. The bonding step, and even the encapsulation step, at this stage of the process can be skipped and the components bonded by plastic deformation if the target density has already been reached in the separately formed at least one powder component. Encapsulation may be useful to remove gaseous impurities from the interface between nested components even if bonding does not occur at this stage.

Thus, the invention provides, among other things, a composite multi-component billet, typically a bi-component hollow billet, of a common structural material clad with a material having somewhat specialized properties, often wear and corrosion resistance. One or more layers can be HIPed or otherwise fabricated using PM techniques to achieve predetermined porosity characteristics correlated to provide a pre-selected flow stress ratio sufficiently small to yield a composite billet that should be able to undergo without failure the plastic deformation that takes place in a forming process such as extrusion.

### BRIEF DESCRIPTION OF THE DRAWINGS

The foregoing and other advantages and features of the invention and the manner in which the same are accomplished will be more readily apparent upon consideration of the following detailed description of the invention taken in conjunction with the accompanying drawings, which illustrate preferred and exemplary embodiments, and in which:

FIG. 1 is a perspective view of a representation of a hollow bi-component composite preform or billet prepared in accordance with the invention;

FIG. 2 is a longitudinal axial cross section of the perform of FIG. 1 illustrating the internal solid layer or core of the hollow preform at a controlled fraction of porosity;

FIG. 3 is a top plan view of the preform of FIG. 1;

FIG. 4 is a bottom plan view of the preform of FIG. 1;

FIG. 5 is a longitudinal axial cross section of a representation of a hollow composite preform or billet of the invention having inner and outer layers of components that are at a controlled fraction of porosity sandwiching a fully dense component;

FIG. 6 is a longitudinal axial cross section of a representation of an encapsulated bi-component billet after filling with powder to maximum packed density and prior to baking-out, evacuation, and sealing;

FIG. 7 is a longitudinal axial cross section of a representation of an encapsulated tri-component billet after filling with powder to maximum packed density and prior to baking-out, evacuation, and sealing;

FIG. 8 is a graphical representation of the results of compression testing (true stress vs. true strain) for HIP consolidated Inconel alloy 625 at various densities and for AISI 8620 steel in wrought condition at 1175° C. and a strain rate of 4 per second;

FIG. 9 is a plot for Inconel alloy 625 showing mean flow stress at various relative densities for three different strain rates and confirms that HIPing Inconel 625 to lower densities decreases the stress required for plastic deformation;

FIG. 10 is a plot of the ratio of mean flow stresses against relative density for Inconel alloy 625 with respect to AISI steel 8620 at various densities for the Inconel alloy 625;

FIG. 11 is a flow diagram of the steps of the method of the invention for determining the desired fraction of porosity of a component and fabricating a bi-component perform;

FIG. 12A is a flow diagram of the steps of one method of the invention for creating a composite, multi-component billet and extruding the billet to produce clad pipe;

FIG. 12B is a flow diagram of the steps of an alternative method to that of FIG. 12A for creating a composite, multi-component billet and extruding the billet to produce clad pipe;

FIG. 13 is a highly schematic representation of the steps of assembling and processing a bi-component billet of the invention;

FIG. 14 is a highly schematic representation of an alternative to the steps of FIG. 13 in which the powder component is partially densified prior to contact with another component;

FIG. 15 is a HIP map of the prior art for Inconel alloy 625 showing the relationship between pressure, temperature, and time with relative density (pore fraction); and

FIG. 16 is a plot taken from the prior art of flow stress against processing temperature for carbon steel and various alloys including Inconel alloy 625 and is shaded to show the range of flow stress compatibility for co-extrusion where one layer of the billet is to be fully dense carbon steel.

Corresponding reference characters indicate corresponding parts throughout the several views of the drawings.

### DETAILED DESCRIPTION

The invention can best be understood with reference to the specific embodiment that is illustrated in the drawings and the variations described hereinbelow. While the invention will be so described, it should be recognized that the invention is not intended to be limited to the embodiments illustrated and described. On the contrary, the invention includes all alternatives, modifications, and equivalents that may be included within the spirit and scope of the invention as defined by the appended claims.

FIG. 1 shows generally at 20 in a perspective view a representation of a hollow, cylindrical bi-component composite billet of the invention. Billet 20 has an outer surface or sleeve 22 of American Iron and Steel Institute (“AISI”) 8620 steel in wrought condition at full density. The sleeve is tapered at one end to form a conical section 24 for entry into an extruder for plastic deformation (not shown in this view). The conical section is chamfered to a flat top surface 25. An inner core layer 26 of Inconel alloy 625, a high nickel content superalloy, is shown in dashed lines within the sleeve 22 and has been metallurgically bonded to the inner surface of the sleeve by hot isostatic pressing (“HIPing”) or other bonding technique. The HIP conditions have been controlled to create or retain a predetermined

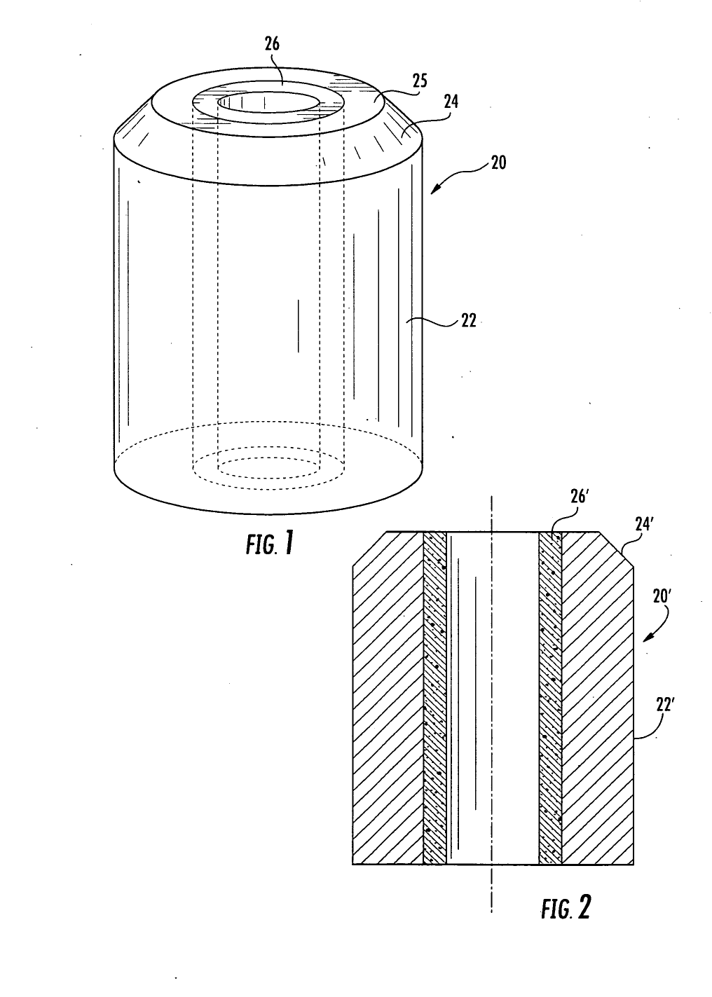

FIG. 2 shows generally at 20′ the billet of FIG. 1 in longitudinal cross section, including the fully dense outer sleeve 22′ of wrought steel and the inner core 26′ of partially dense alloy 625. The hatch lines drawn in the outer sleeve 22′ indicate the sleeve is a fully dense component. The hatch lines drawn in the inner core section 26′ indicate that the powder has been consolidated, and the dots indicate the consolidation is to a partial density, which is to say a fraction of porosity is retained. The fraction of porosity can be pre-determined by computer modeling techniques based on: 1) the temperature, pressure, and time of the HIP cycle; 2) the flow stress exhibited by the powder component undergoing plastic deformation at that predetermined fraction of porosity, which is alloy 625 in FIG. 2; and the flow stress exhibited by the other component or components in the billet assembly, which in FIG. 2 is outer sleeve 22 of wrought AISI 8620 steel.

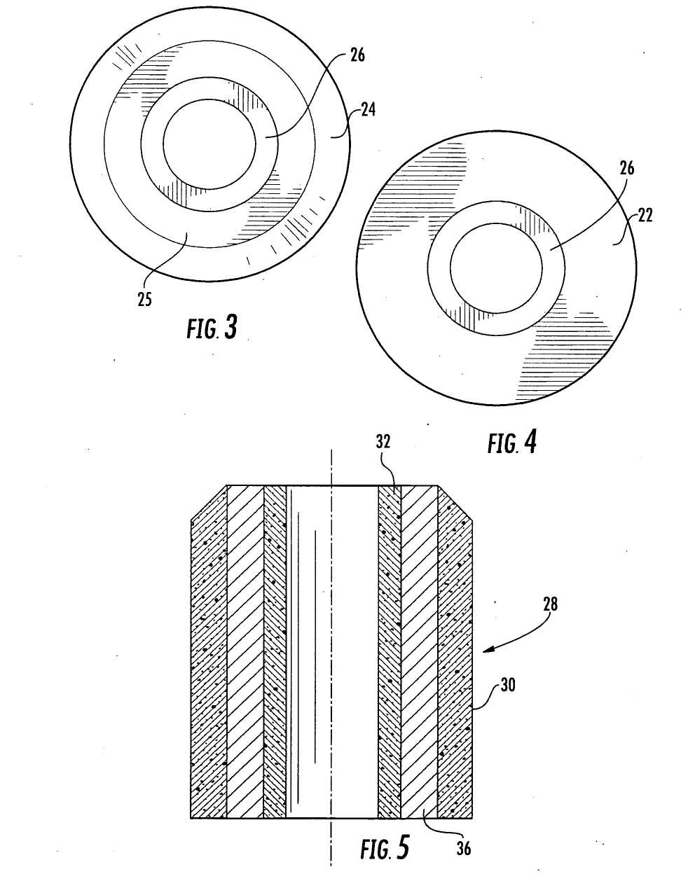

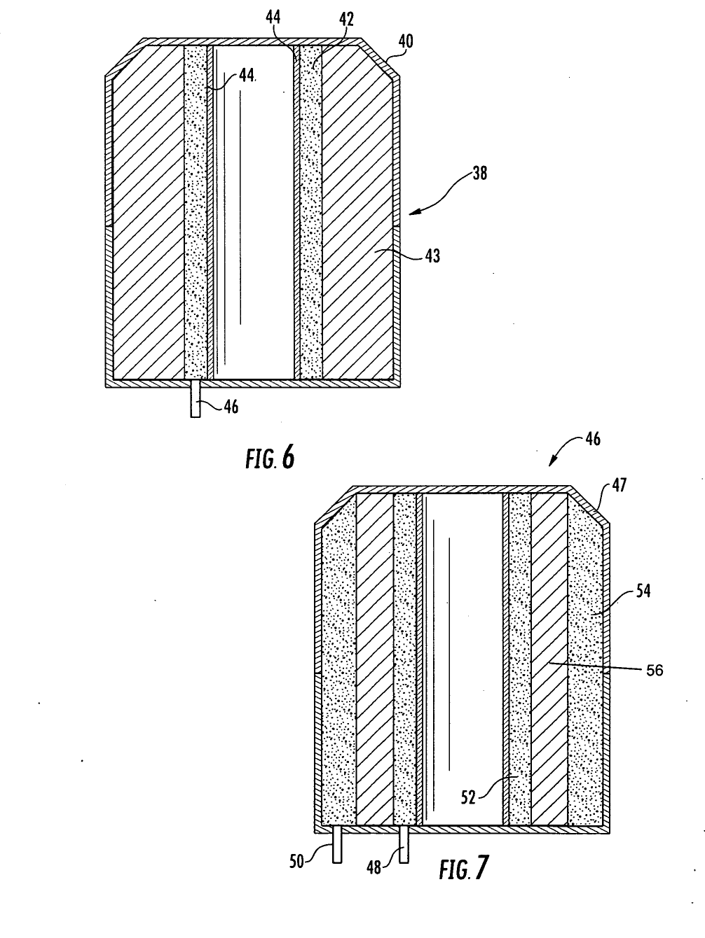

FIGS. 3 and 4 represent top and bottom plan views, respectively, of the billet of FIG. 1. FIG. 3 illustrates the flat top surface 25 of the steel sleeve 22 (FIG. 1) intermediate the conical sleeve surface 24 and the flat top surface of the alloy core.

During the production of multi-layered tubular products via co-extrusion, co-drawing, co-rolling, or other hot working process for plastic deformation, the materials enter the plastic deformation process in the form of a multi-layered, cylindrical billet which is shorter in length but larger in diameter then the dimensions of the finished product. The individual layers or components are chosen for different reasons. One layer may be selected because of the structural strength it provides the finished product, another layer may be selected because it provides superior wear- or corrosion-resistance. Another layer may be selected because it has superior electrical- or thermal-conductivity. The cost of the materials that make up the layers within the billet is always a factor. The choice of Inconel 625 and mild steel for the illustration of the invention should be considered in the context of the invention and its breadth of application to a variety of components, plastic deformation processes, and product configurations.

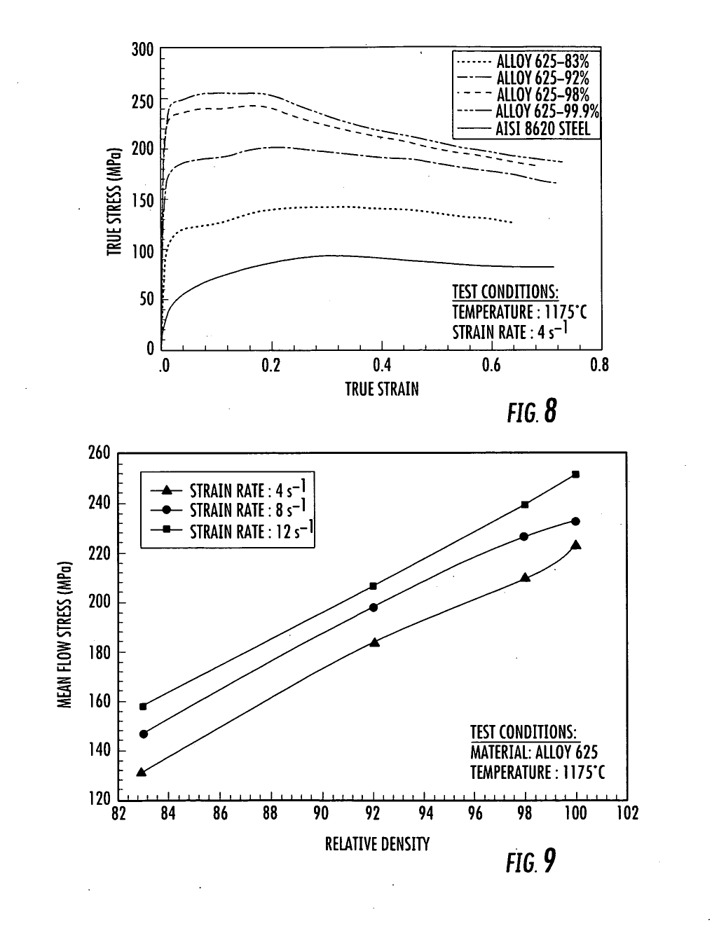

FIG. 5 represents an alternative embodiment of the invention, which is a longitudinal axial cross section of a hollow composite billet shown generally at 28 and having inner and outer layers 32 and 30, respectively, of powder components that are at a controlled fraction of porosity sandwiching a fully dense component layer 36. Sandwich layer 36 is illustrated to be a fully dense solid structural layer and can include, for example, wrought or cast AISI 8620 steel. The structural layer 36 is sandwiched by powder layers 32 and 30 on the inner and outer surfaces of the structural layer 36, the powder layers illustrated as being in a partially consolidated condition and having a predetermined fraction of porosity, the fraction of porosity predetermined to provide a flow stress ratio compatible with that of the structural layer for processing by hot working and plastic deformation. One or both of the inner and outer layers can comprise powder metallurgy materials that are from the same or different materials. For example, each layer could comprise Inconel 625 for corrosion resistance. The components can also be different, including, for example, a wear resistant alloy in one layer and a corrosion resistant or other alloy in the other layer, again depending on the properties needed.

It should be recognized that structural layers and powder layers can be placed in the billet configuration as needed and depending on the application of the end product, so long as the components are treated by heat, temperature, and pressure to a predetermined fraction of porosity in the powder components to provide flow stresses compatible with the other billet components for hot working plastic deformation processes. The preform 20 shown in FIG. 1 has the corrosion resistant alloy placed on the interior surface of the hollow billet. It should be recognized that the corrosion resistant alloy can be placed on the exterior and the wrought carbon steel on the interior of the billet, depending on need. For example, clad steel heat exchanger tubing in which a corrosive fluid is used as the cooling or heating medium might call for the corrosion resistant alloy to be clad on the outside as the exterior surface. The preform can be formed with corrosion resistant alloy or other special alloy on both the inside and outside surfaces of an alloy chosen for its structural properties, again depending on the intended environment of use, FIG. 5.

It should also be recognized that the powder layers can be prepared as solids in situ in a billet assembly or prior to placement in the billet assembly. The target density can vary from partial to full density depending on the flow stresses desired and those exhibited by the component at various densities. If prepared in advance to target density, then diffusion bonding will typically be performed at conditions to avoid further densification if accomplished as a separate step. If prepared below target density, then the conditions should be selected to reach target density. Alternatively, if target density has been reached, then bonding can be performed by plastic deformation, in which event all components become fully dense in the product of plastic deformation, including extrusions.

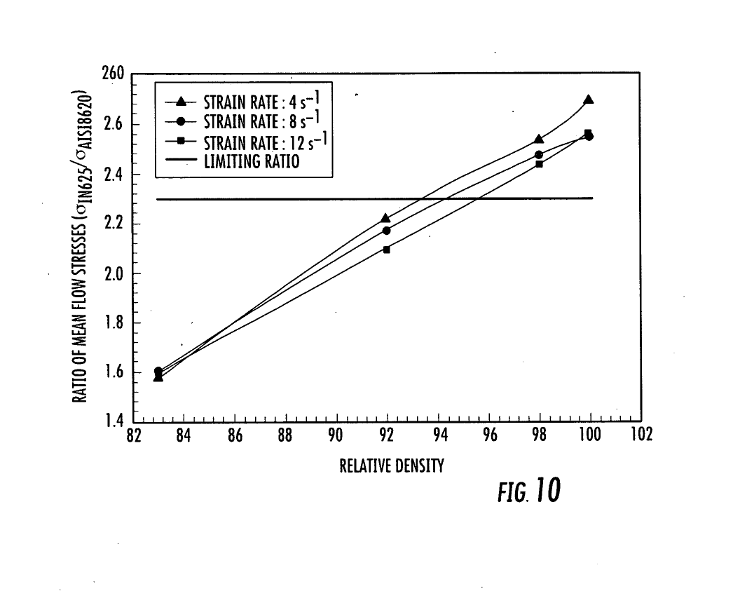

FIG. 6 represents generally at 38 and in longitudinal cross section an embodiment of the bi-component billet of FIGS. 1 and 2 prior to treatment to HIP. The billet 38 is encapsulated by a capsule 40, which is a fully dense thin layer of a metal used for containing the powder component 42 adjacent the solid steel component 43 and for providing a space that can be evacuated of vapor and contaminating gaseous impurities. Capsule 40 is but one of several potential configurations for containers for the billet. FIG. 1 shows capsule 40 having been removed from the billet prior to extrusion, although it should be recognized that capsules sometimes remain on billets in conventional processing and can be useful in assisting the extrusion or other processing technique. Some extrusion techniques, including hydrostatic extrusion, typically require the capsule to be present. Capsules typically are removed by machining or pickling, whether before or after the extrusion or other plastic deformation technique.

Capsule 40 has internal walls 44 providing an annular space for containing the powder 42. Powder 42 enters the annular space through a metal port or tube 46. Typically, to fill a billet capsule with powder, the capsule is placed on a vibratory table and a hopper supplies the powder to the port 46. Vibration enables powder packing at maximum density, which typically is form about 62 to 72% of theoretical full density for a spherical powder, which full density is the absence of pores. The filled capsule is transferred to a bake-out station, including, for example, an open-top oven heated to 550 to 750° F. and evacuation system. During bake-out, a vacuum is pulled at the port 46 to remove air, water vapor, and other gases present on the powder and within the capsule. The evacuated billet is then sealed under vacuum by crimping tube 46 and tube 46 is removed and welded shut to ensure hermetic sealing.

FIG. 7 represents generally at 46 and in longitudinal cross section an embodiment of the multi-component composite billet of FIG. 5 prior to HIP treatment to diffusion bond the layers, and is similar to FIG. 6 in this regard. Billet 46 is encapsulated in a similar manner with a capsule 47 and provides independent loading and vacuum ports 48 and 50 for the inner powder layer 52 and the outer powder layer 54, respectively. Inner and outer powder layers 48 and 50 sandwich a dense metal layer 56 as discussed in connection with FIG. 5. It should also be recognized that metal layer 56 can be prepared by powder metallurgy as a partially dense solid or fully dense solid component prior to encapsulation and can then be treated to diffusion bonding and target density.

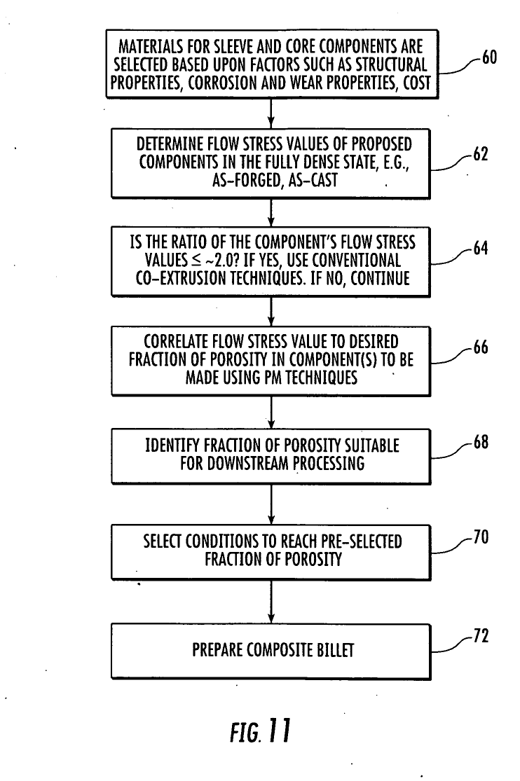

FIG. 8 is a graph showing the results of compression testing for four samples of Inconel 625 superalloy HIP consolidated to varying density levels, compared with fully dense AISI 8620 wrought steel at 1175° C. and at a strain rate of 4 per second. The four Inconel 625 samples are at four densities of 83%, 92%, 98%, and 99.9% of pore-free density. True stress is plotted against true strain. To produce the samples for mechanical testing, alloy 625 metal powder is filled into cylindrical stainless steel (AISI 304) capsules (1.5 inch OD×6 inch Length, 0.0625 inch wall thickness). The capsules are vibrated during filling to ensure that a maximum packing density of about 0.65 is achieved. These capsules are subsequently evacuated, baked-out, and sealed.

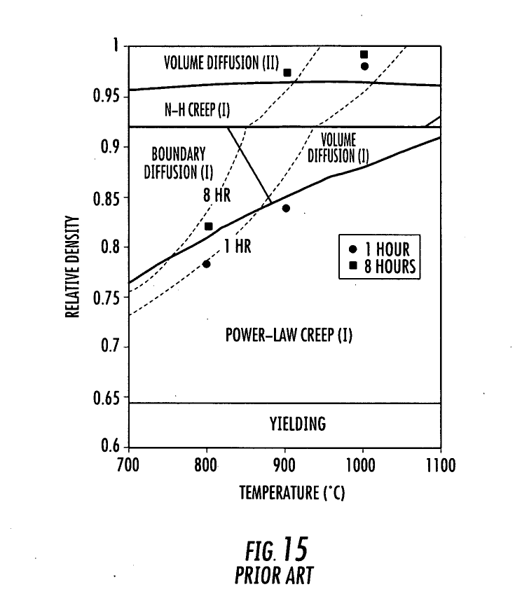

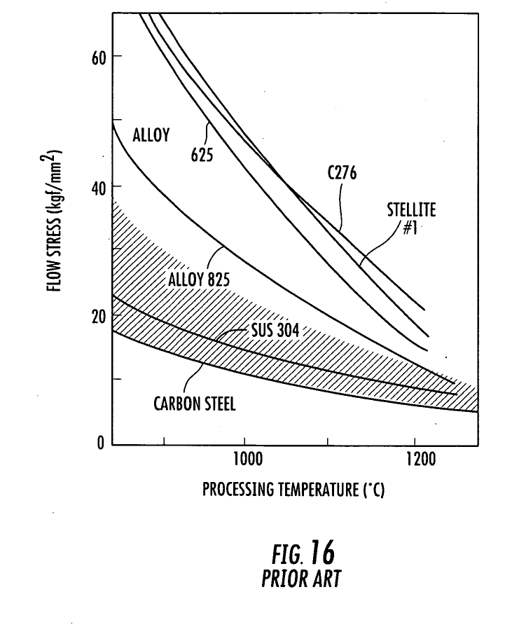

The four density levels (83%, 92% and 98%, and 99.9%) were identified as being appropriate for characterizing the pore fraction and flow stress relationship. This characterization allows identification of the ideal target density level for the simultaneous processing of alloy 625 and AISI 8620 steel. The “HIP 6.0” process software, entitled “Software for Constructing Maps for Sintering and Hot Isostatic Pressing” (1990), which was developed by Professor M. F. Ashby at Cambridge University and is available in the public literature, was employed to determine the HIP conditions to achieve these varied density levels. Those HIP processing parameters are specified in Table I, below, and are determined from HIP maps similar to the one presented in FIG. 15. After HIPing, the stainless steel capsule would be removed from the consolidated superalloy powder by machining.

TABLE I
HIP conditions for producing target density (estimated
using HIP 6.0 model and data from literature)

| Target Relative | | | |
|---|---|---|---|
| Density | Temperature | Pressure | Time |
| (% theoretical) | (° F.) | (PSI) | (hrs) |
| 83 | 1600 | 5000 | 1 |
| 92 | 1700 | 5000 | 1 |
| 98 | 1700 | 10,000 | 1 |
| 99.9 | 1900 | 10,000 | 1 |

Compression testing was performed at three levels of strain rates using a deformation dilatometer to determine the flow stresses of AISI 8620 steel in wrought condition and alloy 625 at the four density levels. Samples for compression testing are machined out from wrought AISI 8620 rod and HIP consolidated Alloy 625 bars. The test matrix for compression testing is specified in Table II below.

TABLE II
Test matrix for compression testing

| | % of Theoretical | True strain rate (1/sec) | | |
|---|---|---|---|---|
| Material | Density | 4 | 8 | 12 |
| Alloy 625 | 83 | 4 | 8 | 12 |
| Alloy 625 | 92 | 4 | 8 | 12 |
| Alloy 625 | 98 | 4 | 8 | 12 |
| Alloy 625 | 99.9 | 4 | 8 | 12 |
| AISI 8620 steel | pore free | 4 | 8 | 12 |

For each testing condition listed in Table II, the samples were heated to 1175° C., +/−5° C. at a nominal rate of 10° C./min. The test specimens were held at this temperature for 5 minutes and then compressed to at least to the total strain of 0.5. It is important to note that the testing machine was run in strain controlled mode to keep the constant true strain rate throughout the test, and the data was collected at a high rate to capture all of the changes in the stress/strain curve during the test. Each test condition specified in Table II was repeated three times to ensure consistency in the results.

FIG. 4 shows the data collected from one set of tests conducted at 1175° C. and a 4 per second strain rate. From this graph, it is evident that the flow stress required for plastic deformation of alloy 625 decreases in the samples with decreasing density and conversely with increasing pore fraction. The flow stress of AISI 8620 steel is still lower than alloy 625 at 83% theoretical density. These observations are found to be consistent for all other strain rates specified in Table II.

In order to quantify the relationship of flow stress with density of alloy 625 from the true stress-strain curve at each testing condition in Table II and their repetitions, mean flow stress is estimated using equation 1 below:

$${\overline{σ}}_{0} = \frac{1}{{ɛ}_{a} - {ɛ}_{b}} {\int }_{{ɛ}_{b}}^{{ɛ}_{a}} {σ}_{0} \cdot d ɛ \qquad Equation 1$$

Where, εₐ and ε_{b} are the upper and lower bounds of plastic strains, respectively. Calculation of mean flow stress using Equation 1 is schematically represented in the graph below. The area under stress and strain curve, which is the shaded region in the graph below, represents the integral term in equation 1 and is estimated by numerical integration techniques.

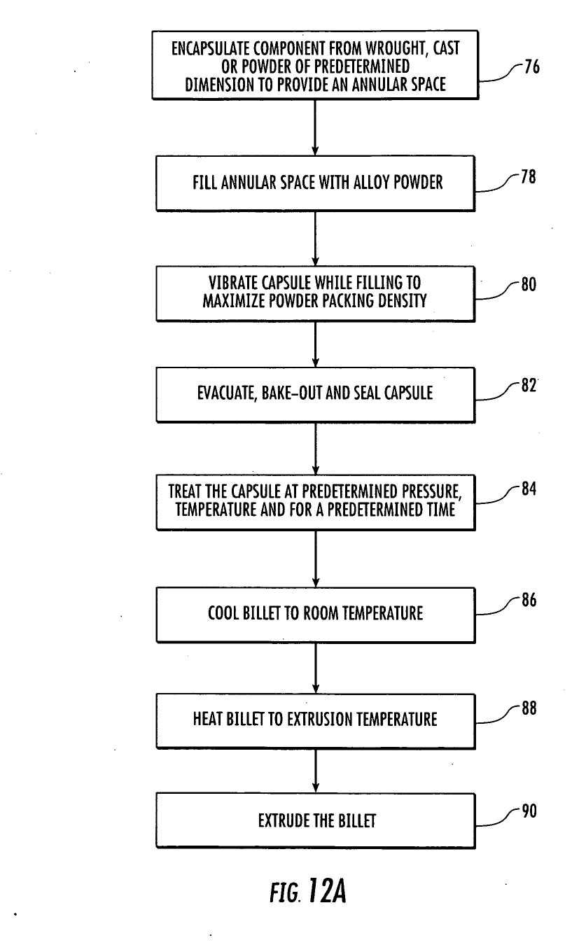

Returning now to the drawings, FIG. 9 is a plot for Inconel 625 showing mean flow stress at various relative densities for three different strain rates and confirms that HIPing Inconel 625 to lower densities decreases the stress required for plastic deformation. Mean flow stress for alloy 625 varies with density at three levels of strain rates. Each data point in FIG. 9 is an average of three test repetitions. The FIG. 9 graph confirms that mean flow stress required to permanently deform alloy 625 can be considerably decreased, at all strain rates, by HIPing it to lower densities.

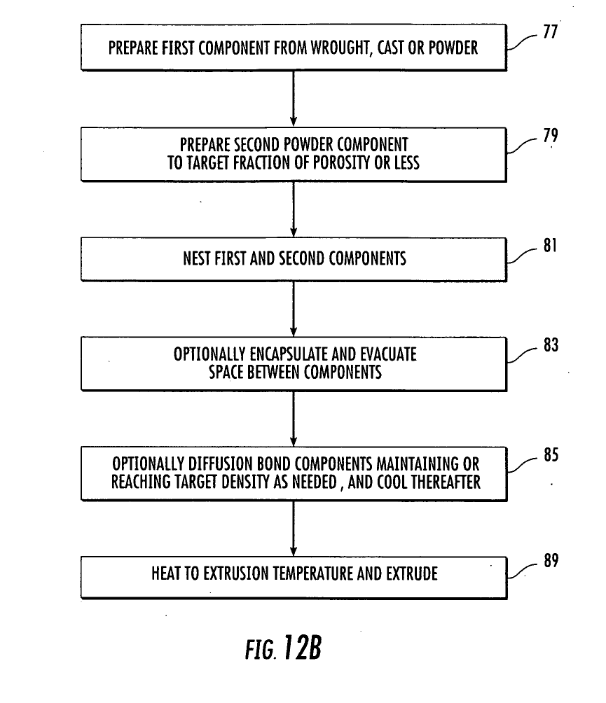

Previous research studies have reported that for the successful hot working of a corrosion resistant alloy/carbon steel preform, the ratio of flow stresses should be less than 2.3. FIG. 10 shows the variation at three different strain rates of 4, 8 and 12 per second of the ratio of mean flow stress of alloy 625 with respect to the mean flow stress of AISI 8620 steel with density of alloy 625, at each level of strain rate. The limiting ratio for successful extrusion, 2.3, is also plotted in FIG. 7 for comparison, as the horizontal black line. It is unlikely that a bimetallic preform could successfully be hot worked above this line. This graph clearly indicates that the ratio of flow stress can be considerably lowered below 2.3 by tailoring the final density of alloy 625 during HIP processing. It is also worth noticing that the influence of strain rate on the ratio of flow stresses is minimal. At strain rates of from 4 to 12 per second, an alloy 625 layer having a density of 92% of full density or less should be suitable for processing in accordance with the invention.

FIG. 11 illustrates a flow diagram of the steps of the method of the invention for determining the desired fraction of porosity of a component of a preform. Initially, the billet components are selected in accordance with step 60 and the desired flow stress values determined based on components. For example, the materials for the sleeve (case) and core and additional layers, if any, typically will be selected depending on factors including structural properties, corrosion and wear resistance, and cost. Other factors may be important, depending on the end use of the product. Thereafter, in accordance with step 62, the flow stress values are determined for the proposed components in their fully dense state, which is an as-cast or forged state, or a PM materials consolidated to full density including those components that are proposed for use in the practice of the invention in a cast or forged state, such as wrought mild steel. It should be recognized that all or a majority of the components of a multi-component billet may be prepared from powder, if desired. If the ratio of these flow stresses is no more than about 2.0 to perhaps as high as 2.3, then, in accordance with step 64, conventional co-extrusion or other conventional plastic deformation techniques can be used, or the method of the invention can be practiced as desired. If the ratio of flow stress

[symbol]

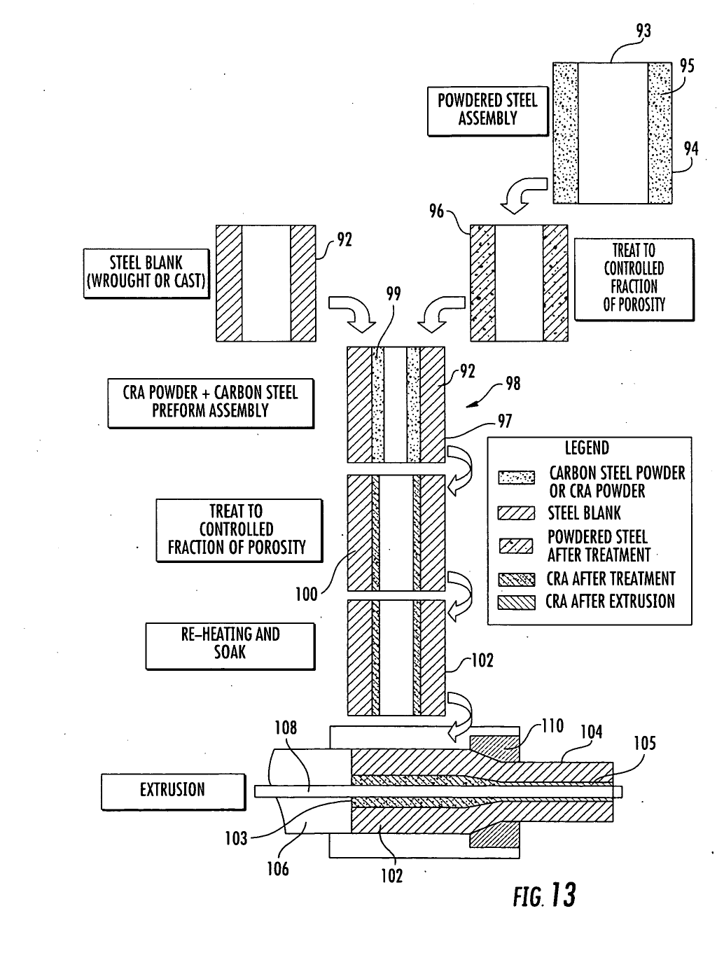

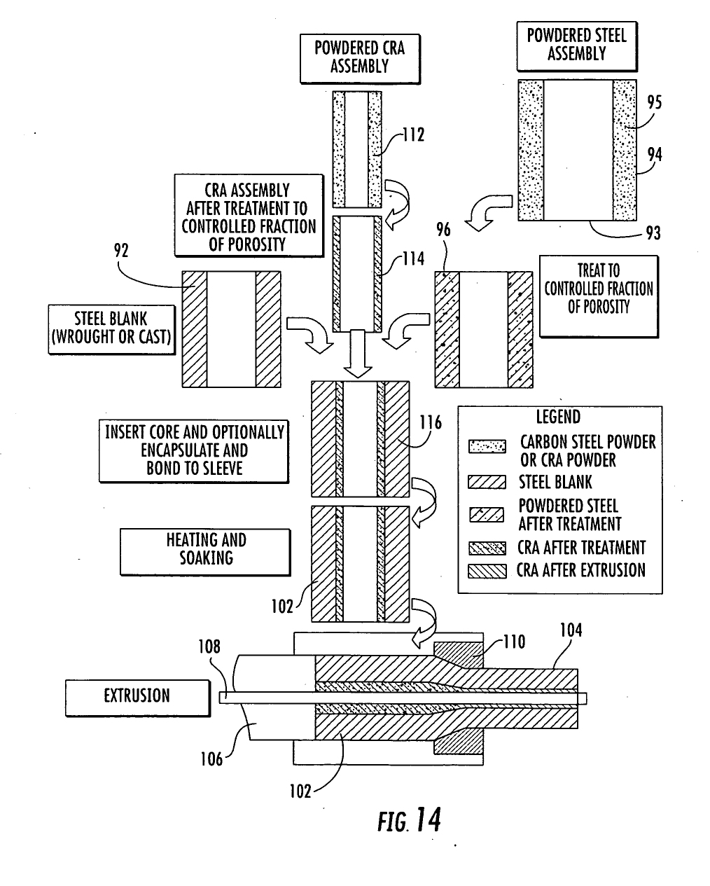

FIG. 12A illustrates a flow diagram of the steps of the method of the invention for creating and extruding a composite, multi-component hollow perform having at least one component from powder and one from solid metal, in which the powder component is not consolidated until assembled in the perform. It should be recognized that the representations in the FIG. 1 to which FIG. 12A is directed of a bi-component hollow billet, are not intended to be exclusive, and, on the contrary indicate the wide variety of potential configurations and materials useful in the practice of the invention. Using the information determined in accordance with FIG. 11, powder components can be pre-consolidated and then assembled into a billet if desired and treated to fusion bond the layers at the desired porosities and flow stress ratios, as has been described above and as shown in connection with FIG. 12B.

FIG. 12A illustrates at 76 the initial step of encapsulating the solid component, including, for example, wrought steel, of predetermined dimensions suitable for a billet for extrusion. The capsule provides an annular space for the powder component to be filled, step 78. The capsule is vibrated during filling, step 80, to maximize powder packing density and is then evacuated, baked-out, and sealed, as described above in connection with FIG. 6. The capsule is HIPed or otherwise subjected to conditions of temperature, pressure, and time to diffusion bond the components and to bring the components to compatible densities for co-extrusion or other processing, step 84. Typically, the powder component will be consolidated to something less than full density. The assembled and HIPed billet is then cooled to ambient, step 86, and thereafter reheated to extrusion temperature, step 88, and extruded, step 90.

A conventional electric, oil, or gas furnace or induction heating may be used to re-heat the billet. Additional steps typically may be included, such as holding the re-heated billet at a high temperature for a period of time, sometimes called “soaking” the billet, to dissolve intermetallic compounds at the interface of the diffusion bonded surfaces. For Inconel 625 alloy and wrought steel, the soaking temperature will be from about 900 to 1200° C. for a time appropriate to the diameter of the billet typically varying from one-half hour to four hours.

FIG. 12B is a flow diagram illustrating the steps of preparing the billet components separately and then assembling these components, in which at least one component is partially densified. In accordance with step 77, a first component is prepared from wrought, cast or powder. A second component is prepared from powder and subjected to heat, pressure and temperature to a target fraction of porosity, step 79. The second component could be treated to less than the target fraction, if desired. The capsule is removed from the second component. Next, the first and second components, or more if a multi-component billet assembly of more than two layers is intended, are nested and fitted together, step 81. At this stage, the billet assembly can optionally be encapsulated and the space between the components evacuated, if needed, step 83. The billet assembly can also be treated, if desired, to reach target density and diffusion bond the components or to maintain a previously obtained target density and diffusion bond the components, step 85, followed by cooling to room temperature. Thereafter, the billet assembly is heated to extrusion temperature and extruded or otherwise subjected to plastic deformation.

Assembly, consolidation, and extrusion of a billet from powder as described in connection with FIG. 12A is illustrated in a highly schematic way in connection with FIG. 13. Assembly can start with either a wrought or cast steel blank 92 or other solid, fully dense metal form of predetermined dimensions suitable for the planned billet. Alternatively, assembly can start with a powdered steel or other metal and capsule assembly 94, the capsule 93 containing a powdered metal 95 at maximum packing density. The powdered steel assembly is HIPed or otherwise treated at conditions of pressure, temperature, and time to become a solid 96 having a predetermined fraction of porosity, including a fully dense solid, in which case we have solid blank 92. The capsule from blank 96 would typically be removed prior to proceeding to assemble the billet of the invention, either by machining or pickling.

A capsule 97 is provided for the assembly, shown generally at 98, creating an annular space for the powder, in this case a corrosion resistant alloy (“CRA”) powder 99, and the billet 98 is assembled in a manner described above in connection with FIG. 6. The assembled billet is HIPed, 100, or otherwise treated under conditions of pressure, temperature, and time to diffusion bond the powder to the wrought or previously consolidated layer and to provide the requisite fraction of porosity in the CRA powder. The HIPed billet is then re-heated and soaked, 102, and extruded 104, typically with lubrication applied. Extrusion or other hot working plastic deformation processes develop full density in the layers as they are deformed and FIG. 13 indicates that partially dense layer 103 becomes fully dense, 105, on passing through the extrusion orifice. In the illustration of FIG. 13, the extrusion is a direct extrusion by a ram 106 of a hollow bi-component billet 102 on a supporting mandrel 108 through an extrusion orifice 110 to form clad pipe 104.

Direct extrusion is but one example of a wide variety of techniques for plastic deformation that may be used in connection with the invention to produce a variety of shapes. Some of the processes for plastic deformation useful in the practice of the invention include Pilger milling and direct and indirect extrusion. Drawing, Mannesmann milling, and several others should also be suitable, although not necessarily with equivalent results.

Plastic deformation may be defined as an irreversible change in the shape or size of an object due to an applied force or strain, including tensile force, compressive force, shear, bending, or torsion. If the material subjected to strain fractures, then its limits of plastic deformation have been exceeded. One of the issues in creating clad seamless pipe that has been described as failure, due to fracture of the sleeve or core or non-uniform or disproportional flow, can also be understood in terms of the components having too radically different responses to the strain applied. Typically, the limits of plastic deformation for one component are exceeded prior to the other. The invention provides a billet that can successfully be subjected to plastic deformation to provide a product that does not fail.

FIG. 14 is a highly schematic representation of an alternative to the steps of FIG. 13 corresponding to flow diagram FIG. 12B, in which the powder component is partially densified prior to contact with another component. As in the case of FIG. 13, the assembly may be started with either a wrought or cast steel blank 92 or other dense metal, or a powdered and at least partially densified blank 95. However, in the FIG. 14, the corrosion resistant alloy or other alloy powder 112 is encapsulated and densified separately from the assembly to form a blank 114. This blank 114 may need to be machined on its interior and exterior surfaces prior to assembly by nesting in the billet 116. The billet 114 is then optionally HIPed or otherwise treated under conditions of pressure, temperature, and time, to diffusion bond the layers and to reach the target density for the powder layer. It should be recognized that the powder layer could have already been brought to target density when first subjected to HIP or other processing. In this event, it may be desired to encapsulate the billet to evacuate the interface between components and to then proceed to heating and soaking and extrusion, which will bond the components. If desired, bonding can occur at 116, the conditions being managed at 116 to provide diffusion bonding while maintaining the fraction of porosity. Re-heating, soaking, and extrusion are the same as in FIG. 13.

It should be recognized that the principles of the invention can be applied to a variety of metal, ceramic, and thermoplastic components, depending on the properties desired in the final product, although not necessarily with equivalent results. Preforms built in connection with the practice of the invention and for producing clad pipe or tubing normally can be described as composite multi-component hollow or solid cylindrical blocks, and typically are bi-component blocks made from two concentric layers of different metal alloys. In multi-component structures, there may be included additional concentric layers of different alloys or other materials to enhance metallurgical bonding or particular mechanical characteristics. These additional layers can be referred to as “interlayers” and typically are placed between the sleeve and core. Multi-component structures are also intended to be included in which multiple layers are selected as described in connection with FIG. 5.

The invention provides a significant extension to the material combinations that presently are suitable for producing clad pipe. The invention as described herein expands the range of components by adjusting the porosity of at least one of the PM components of a composite billet. The invention has been described with specific reference to preferred embodiments. However, variants can be made within the scope and spirit of the invention as described in the foregoing specification as defined in the appended claims.

What is claimed is:

1. A multi-component clad billet having at least first and second components inter-metallically bonded, said first and second components exhibiting first and second flow stresses, respectively, in response to plastic deformation, and wherein at least one of said first and second components has a pore volume greater than zero, the pore volume predetermined to provide a corresponding flow stress compatible with the flow stress of the other component.

2. The clad billet of claim 1 wherein the billet is a hollow bi-component billet, the first component is fully dense carbon steel, and the second component is a nickel-based alloy powder partially consolidated to a density of 92% of full density or less.

3. The clad billet of claim 2 wherein said density ranges from about 83 to 92% of full density.

4. The clad billet of claim 1 wherein said pore volume is not less than from about 62 to 72% of theoretical full density for a spherical powder.

5. The clad billet of claim 1 wherein said billet is a hot isostatically pressed billet and said pore volume is determined by hot isostatic pressing conditions of time, temperature, and pressure.

6. The clad billet of claim 1 wherein said pore volume, concentration, and distribution within said component provides compatible flow stress between said first and second components.

7. The clad billet of claim 1 wherein the ratio of said flow stresses of said first and second components is not greater than about 2.0.

8. The clad billet of claim 1 wherein plastic deformation is hot working.

9. The clad billet of claim 1 wherein plastic deformation is a tube production process selected from the group consisting of drawing, direct extrusion, indirect extrusion, Pilger milling, and Mannesmann rolling.

10. The clad billet of claim 1 wherein said billet is a preform for clad pipe or tubing.

11. The clad billet of claim 1 wherein said billet is externally clad, internally clad, or clad on both sides of a blank, said component with said pore volume greater than zero providing said clad and the other one of said components providing said blank.

12. The clad billet of claim 1 wherein said component with said pore volume greater than zero is selected from the group consisting of components exhibiting corrosion resistance, wear resistance, strength, electrical properties, thermal properties, and combinations thereof.

13. The clad billet of claim 1 wherein said component with said pore volume greater than zero is nickel-based alloy and said other component is steel alloy.

14. The clad billet of claim 1 wherein said clad billet is bimetallic.

15. A clad billet having a structural component bonded to a wear or corrosion resistant powder metallurgy alloy component, said powder metallurgy alloy component having a predetermined pore volume greater than zero correlated to provide a flow stress response to plastic deformation sufficiently similar to the flow stress of said structural component to retain said bond after plastic deformation.

16. A method for producing a clad billet for plastic deformation, said method comprising the steps of:
a) providing a first billet component;
b) providing a second billet component adjacent the first billet component;
c) adjusting the porosity of one of the billet components to a predetermined value correlated to produce a flow stress in response to plastic deformation compatible with the flow stress of the other component; and
d) creating a bond between the first and second components.

17. The method of claim 16 wherein the step of providing a first billet component comprises the step of providing a wrought carbon steel blank of predetermined dimensions and flow stress in response to plastic deformation.

18. The method of claim 16 wherein the step of providing a second billet component adjacent the first comprises the steps of:
a) welding a capsule to the first billet to create an annular cavity;
b) filling the annular cavity with corrosion or wear resistant alloy powder; and
c) vibrating the alloy powder while filling the cavity; and
d) evacuating, baking, and sealing the capsule.

19. The method of claim 18 wherein the steps of adjusting the porosity of one of the billet components and creating a bond between the billet components comprises hot isostatically pressing the capsule for a predetermined time at predetermined conditions of temperature and pressure to create said bond and to produce a predetermined porosity.

20. The method of claim 19 further comprising the step of dissolving inter-metallic elements formed at the interface of the billet components.

21. The method of claim 20 wherein the step of dissolving inter-metallic elements comprises heating the clad billet to an extrusion temperature and soaking the billet.

22. The method of claim 21 further comprising the step of lubricating and extruding said billet at a predetermined extrusion ratio.

23. The method of claim 16 further comprising ultrasonically inspecting the integrity of the bond.

24. A method for producing clad pipe or tubing comprising the steps of:
a) providing a wrought steel blank;
b) welding a capsule to the blank to create an annular cavity;
c) filling the annular cavity with corrosion or wear resistant alloy powder;
d) vibrating the alloy powder while filling the cavity;
e) evacuating, baking, and sealing the capsule;
f) hot isostatically pressing (“HIPping”) the encapsulated assembly of steel blank and alloy powder at a pressure and temperature and for a time predetermined to provide a porosity in the alloy correlated with a predetermined flow stress and to bond the alloy powder to the steel blank;
g) cooling the encapsulated assembly to room temperature and removing the assembly from the capsule;
h) removing intermetallic elements from the interface of HIPped components; and
i) extruding the HIPped components at a predetermined extrusion ratio.

25. The method of claim 24 wherein the step of extruding the HIPped components comprises heating the components.
